(19) United States
(12) Patent Application Publication
(10) Pub. No.: US 2017/0111617 A1
(43) Pub. Date: Apr. 20, 2017

(54) IDENTIFICATION OF RECORDED IMAGE DATA

(71) Applicant: EMPIRE TECHNOLOGY DEVELOPMENT LLC, Wilmington, DE (US)

(72) Inventors: Noriaki KUWAHARA, Nara (JP); Tsutomu MIYASATO, Nara (JP); Noriaki MITSUNAGA, Osaka (JP); Rieko KADOBAYASHI, Kyoto (JP); Masataka OHIRA, Saitama (JP)

(73) Assignee: EMPIRE TECHNOLOGY DEVELOPMENT LLC, Wilmington, DE (US)

(21) Appl. No.: 15/127,009

(22) PCT Filed: Mar. 21, 2014
(86) PCT No.: PCT/US14/31522

§ 371 Date: Sep. 17, 2016

(51) Int. Cl. H04N 7/18; H04W 4/02; G11B 27/10

(52) U.S. Cl. CPC H04N 7/18; G11B 27/10; H04W 4/028; H04W 4/023

(57) ABSTRACT

Technologies are generally described for identification of recorded image data. In various examples, a mobile device may include a receiver, a memory and a processor. The receiver may be configured to receive a signal transmission from a surveillance apparatus located proximate to the mobile device, and the signal transmission from the surveillance apparatus includes a camera ID. The processor may be configured to coordinate operation of the receiver and the memory to: store the camera ID received from the receiver in association with a timestamp in the memory; receive a request to identify at least one camera ID associated with a user specified criteria; and identify one or more camera IDs that substantially match the user specified criteria. In some further examples, the mobile device may also be configured to receive image signals captured by one or more surveillance apparatuses that are determined to be proximate to the mobile device at a user specified time, which may be included in the user specified criteria. Such image signals may correspond to one or more of video images, still images, or audio-video images.

### BACKGROUND

Unless otherwise indicated herein, the approaches described in this section are not prior art to the claims in this application and are not admitted to be prior art by inclusion in this section.

Video cameras may be used for any variety of purposes including both personal and commercial uses. The term video camera may refer to any device that is capable of capturing video signals such as analog video signals or digital video signals. Some camera devices that are typically intended for still photography can also be configured to operate in a video mode to enable capture of video signals. Some other camera devices may be designed as standalone video capture devices that are predominately used for capturing video signals. Still other camera devices may be a system of distributed components that are configured to collaboratively capture video signals.

In some instances, one or more video cameras can be configured for use in a surveillance system. A surveillance system can be described as a system that includes a collection of devices that are configured to monitor activity in a region of interest. A typical video surveillance system may include a collection of cameras that are positioned at different angles or locations within a region of interest, where each camera may be utilized to generate one or more video signals that can be captured or viewed at a monitoring station. The activity that is monitored can be any variety of activities such as automotive traffic flow on a highway, human traffic flow in and out of buildings or shopping areas, or monitoring of the security of places containing articles of great value such as in banks, museums, or private residences.

### SUMMARY

Technologies are generally described for identification of recorded images. The recorded images may include video images, still images, or audio-video images, which may be recorded by a surveillance apparatus equipped with an image capture functionality.

Various example mobile devices described herein may include a receiver, a memory and a processor. The receiver may be configured to receive a signal transmission from a surveillance apparatus located proximate to the mobile device, and the signal transmission from the surveillance apparatus includes a camera ID. The processor may be configured to coordinate operation of the receiver and the memory to: store the camera ID received from the receiver in association with a timestamp in the memory; receive a request to identify at least one camera ID associated with a user specified criteria; and identify one or more camera IDs that substantially match the user specified criteria.

In some further examples, the described mobile device may also be configured to receive image signals captured by one or more surveillance apparatuses that are determined to be proximate to the mobile device at a user specified time, which may be included in the user specified criteria. Such image signals may correspond to one or more of video images, still images, or audio-video images.

In some examples, a method performed under control of a mobile device is described such as any example methods described herein that may be performed by any example mobile devices described herein. In accordance with the example method, the mobile device may receive a camera ID from a surveillance apparatus located proximate to the mobile device, and store the camera ID in association with a timestamp in a memory of the mobile device.

In some further examples, the described mobile device may also be configured to send, to a server device, a request to identify one or more camera IDs associated with a user specified criteria. The server device may be communicatively coupled to one or more surveillance apparatuses including the surveillance apparatus and store image data captured by the one or more the surveillance apparatuses together with corresponding camera IDs. Then, the mobile device may be configured to receive, from the server device, image data that identifies at least one camera ID that substantially matches the user specified criteria. The image data may correspond to one or more of video images, still images, or audio-video images.

In some examples, a surveillance apparatus is also described herein. The example surveillance apparatus may include a camera, a memory and a signal transmitter. The camera may be configured to record image data. The memory may be configured to store the recorded image data. The signal transmitter may be configured to transmit a signal to a mobile device located within a predetermined range, and the signal is encoded with a camera ID of the surveillance apparatus. Such image data may include one or more of video images, still images, or audio-video images.

In some examples, a system may include one or more surveillance apparatuses and a server. Each of the one or more surveillance apparatuses may include a camera and a signal transmitter. The camera may be configured to record image data. The signal transmitter may be configured to transmit a signal to a mobile device located within a predetermined range, and the signal is encoded with a camera ID of the surveillance apparatus. The server may be configured to receive the recorded image data from the one or more surveillance apparatuses and store the received image data in a memory of the server. Such image data may include one or more of video images, still images, or audio-video images.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 schematically shows an example of an environment where a user, who is carrying a mobile device, is located within a field of view (FOV) of a surveillance apparatus;

FIG. 2 schematically shows an example system where multiple surveillance apparatuses are coupled to a server via a network;

FIG. 3 schematically shows a block diagram of an example mobile device configured to receive and store a camera ID of a surveillance apparatus;

FIG. 4 schematically shows an example map configured to indicate one or more surveillance apparatuses that record image data and transmit a signal encoded with a camera ID;

FIG. 5 schematically shows a block diagram of an example surveillance apparatus configured to record image data and transmit a signal encoded with a camera ID;

FIG. 6 schematically shows an example flow diagram of a method for handling a camera ID transmitted from a surveillance apparatus;

FIG. 7 schematically shows a flow diagram of an example method performed by a surveillance apparatus;

FIG. 8 schematically shows a flow diagram of an example method performed by a server to which one or more surveillance apparatuses are coupled;

FIG. 9 illustrates computer program products that may be utilized to handle camera IDs of surveillance apparatuses; and

FIG. 10 shows a schematic block diagram illustrating an example computing system that can be configured to implement methods for handling camera IDs,

all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, may be arranged, substituted, combined, separated, and designed in a wide variety of different configurations, all of which are explicitly contemplated herein.

This disclosure is generally drawn, inter alia, to methods, apparatus, systems, devices and computer program products related to identify recorded image data.

Briefly stated, technologies are generally described for handling a camera ID of a surveillance apparatus to identify image data recorded by the surveillance apparatus. Such image data may include one or more of video images, still images, or audio-video images. In various examples, a surveillance apparatus may transmit a corresponding camera ID to a mobile device located within a field of view (FOV) of the surveillance apparatus. Image data recorded by the surveillance apparatus may be associated with the mobile device (and consequently a user of the mobile device) when located within the FOV of the surveillance apparatus. The mobile device may be configured to receive the camera ID and store the camera ID in association with a timestamp in a local memory.

In some embodiments, the mobile device may subsequently search the local memory to identify one or more camera IDs that are stored proximate to a user specified time. The search may be based on at least one timestamp stored together with the at least one camera ID in the local memory.

In some embodiments, the surveillance apparatus may be configured to store the recorded image data in its local memory and/or a remote storage device, and the stored image data may be provided to the user of the mobile device or an authorized user upon his/her request. In some examples, the mobile device may access the surveillance apparatus or the remote storage device to download the recorded image data.

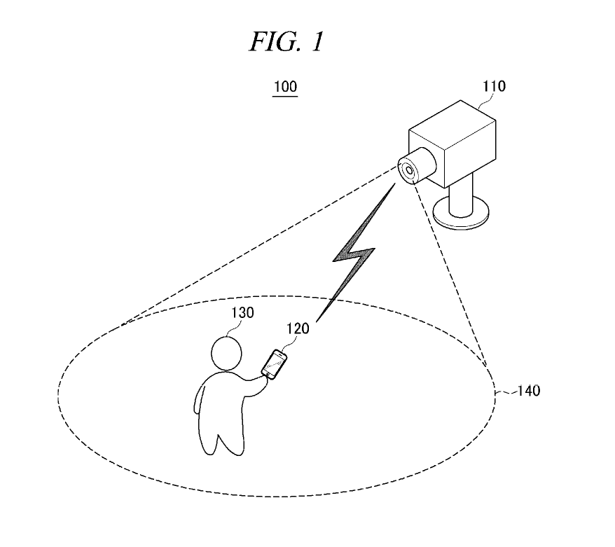

FIG. 1 schematically shows an illustrative example of an environment 100 where a user 130, who is carrying a mobile device 120, is located within a field of view (FOV) 140 of a surveillance apparatus 110, arranged in accordance with at least some embodiments described herein.

As depicted in FIG. 1, surveillance apparatus 110 may record image data of user 130 and/or his/her mobile device 120, both of which are located within FOV 140 of surveillance apparatus 110. FOV 140 (shown as a broken line in FIG. 1) may be an area that surveillance apparatus 110 can distinguish and/or identify an object located within the area. In some embodiments, surveillance apparatus 110 may be configured to store the recorded image data in a local memory. Surveillance apparatus 110 may further be configured to store the recorded image data in a remote storage device which is communicatively coupled to surveillance apparatus 110 via a network.

In some embodiments, the stored image data may be provided to user 130 or an authorized user upon his/her request. By way of example, but not limitation, user 130 may want to obtain image data captured by surveillance apparatus 110 when, for example, he/she is in a theme park. By way of another example, but not limitation, user 130 may want to use surveillance apparatus 110 to take a picture when the camera angle of surveillance apparatus 110 is better than what can be captured by his/her own camera. In such cases, user 130 may access, using mobile device 120 (or any other electronic devices that provide a communication functionality), surveillance apparatus 110 or the remote storage device to download the stored image data.

Further, the surveillance apparatus 110 may be configured to transmit, within a predetermined range, a signal 150 encoded with a camera ID of surveillance apparatus 110. In some embodiments, the predetermined range may correspond to FOV 140 of surveillance apparatus 110 so that a signal receiver device located within FOV 140, such as mobile device 120, may receive signal 150. By way of example, but not limitation, surveillance apparatus 110 may be configured to transmit signal 150 as a directional signal using a directional antenna such that the predetermined range corresponds to FOV 140 of surveillance apparatus 110. Further, surveillance apparatus 110 may be configured to transmit signal 150 with a predetermined power level such that the predetermined range corresponds to FOV 140 of surveillance apparatus 110. Surveillance apparatus 110 may also be configured to transmit signal 150 via any type of wireless transmission including, but not limited to, radio waves, infrared (IR), Bluetooth, Zigbee, Wi-Fi, etc. The camera ID of surveillance apparatus 110 may be any type of information (e.g., digital or analog) that can be utilized to identify surveillance apparatus 110.

As depicted in FIG. 1, user 130, who is carrying mobile device 120, may be located within FOV 140 of surveillance apparatus 110. Mobile device 120 may be of any type of mobile device including, for example, a smartphone, a mobile phone, a personal digital assistant (PDA), a tablet device, a laptop, a hybrid of the aforementioned devices (e.g., a “phablet”), a mobile game console, an internet appliance device, a car device with Wi-Fi capability etc. Mobile device 120 may be configured to receive the camera ID of surveillance apparatus 110, which may be encoded in signal 150 from surveillance apparatus 110. Mobile device 120 may be configured to store, in a local memory, each received camera ID in association with a corresponding timestamp. The timestamp may relate to a time when the mobile device 120 (and hence user 130) is located within FOV 140 of surveillance apparatus 110 and may include date information in addition to time information. In some embodiments, mobile device 120 may be configured to generate a timestamp that indicates a specific time when mobile device 120 receives the camera ID of surveillance apparatus 110. In some other embodiments, mobile device 120 may receive a timestamp which may be encoded into signal 150 together with the camera ID from surveillance apparatus 110. In such cases, surveillance apparatus 110 may be configured to generate the timestamp that corresponds to a time of recording image data of user 130 and transmit, to mobile device 120, the timestamp together with the camera ID via signal 150. Further, surveillance apparatus 110 may be configured to store each timestamp in association with the recorded image data in the corresponding local memory and/or in the remote storage device. In some examples, surveillance apparatus 110 may be configured to receive a mobile device ID (e.g., IMSI or some other identifiers) that is received from mobile device 120, such that the recorded image data may be stored in association with the mobile device ID. Subsequently, mobile device 120 may access surveillance apparatus 110 or the remote storage device based on the mobile device ID to identify and access the recorded image data. Access may be provided via any reasonable method such as initiating download of the recorded image data, transmitting a link to the recorded image data, etc.

In some embodiments, surveillance apparatus 110 may be associated with an SNS (Social Network Service) server, which may be configured to communicate with mobile device 120 based on persistent login authentication. In such cases, surveillance apparatus 110 may be configured to receive the mobile device ID of mobile device 120 and notify user 130 of the recorded image data through the SNS server. By way of example, but not limitation, surveillance apparatus 110 may transmit the mobile device ID and/or the recorded image data to the SNS server, and the SNS server may identify user 130 based on the mobile device ID and transmit a notification of the recorded image data to mobile device 120. Subsequently, mobile device 120 may access surveillance apparatus or the SNS server to access the recorded image data (e.g., by initiating download of the recorded data, transmitting a link to the recorded image data, etc.).

Although, in the above descriptions relating to FIG. 1, mobile device 120 is described as receiving the camera ID of surveillance apparatus 110, mobile device 120 may further be configured to receive one or more other camera IDs from one or more other surveillance apparatuses, when mobile device 120 is located within respective fields of view of the one or more other surveillance apparatuses. In such cases, mobile device 120 may be configured to store, in the local memory, each received camera ID in association with respective timestamps, which may be generated by mobile device 120 and/or received from at least one of the surveillance apparatuses.

In some embodiments, when user 130 wishes to identify at least one camera ID about a specific time from among one or more camera IDs received from respective surveillance apparatuses and stored in the local memory of mobile device 120, user 130 may input a request to identify at least one camera ID using a user interface such as, for example, a touch panel, a keyboard, etc. The request may include a specified time that is designated by user 130. The specified time may correspond to a precise time, an approximate time, a range/span of times, a time period, or any other reasonable way to specify a time where the user may expect that image data may have been obtained with a surveillance apparatus. Upon receiving the request, mobile device 120 may provide the at least one identified camera ID about the specific time to user 130. By way of example, but not limitation, mobile device 120 may display a list of the at least one identified camera ID on a display which may be operatively coupled to mobile device 120. In some further examples, mobile device 120 may be configured to receive one or more image data that correspond to the at least one identified camera ID at the specified time from one or more corresponding surveillance apparatuses and display the received one or more image data in the display.

In some additional embodiments, when user 130 wishes to identify at least one camera ID about a specific location from among the one or more camera IDs stored in the local memory of mobile device 120, user 130 may also input a request to identify at least one camera ID using the user interface, as described above. The request may include a specified location that is designated by user 130. By way of example, but not limitation, user 130 may specify a location by designating a street address, a name of business, a GPS coordinate, etc. Further, user 130 may specify an approximate location, for example, by selecting a point on a map displayed on a display of user device 120. The specified location may be determined by any other ways of specifying an exact location, an approximate location, or a range of locations. Upon receiving the request, mobile device 120 may provide the at least one identified camera ID about the specified location to user 130. By way of example, but not limitation, mobile device 120 may display a list of the at least one identified camera ID on a display which may be operatively coupled to mobile device 120. In some further examples, mobile device 120 may be configured to receive one or more image data that correspond to the at least one identified camera ID at the specified location from one or more corresponding surveillance apparatuses and display the received one or more image data in the display.

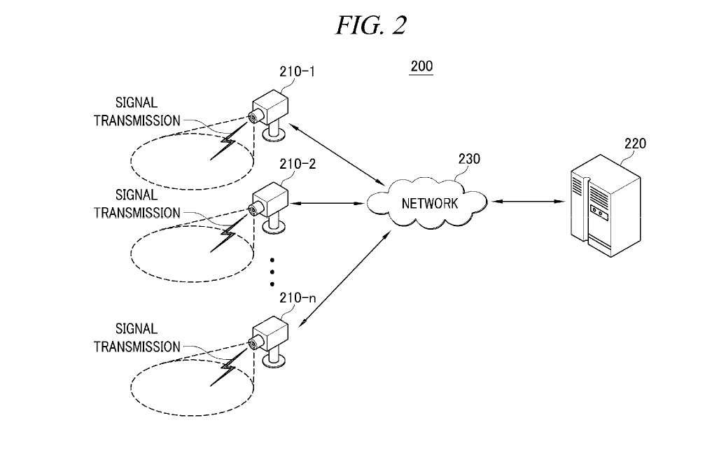

FIG. 2 schematically shows an example system 200 where multiple surveillance apparatuses 210-1, 210-2, . . . , and 210-n are coupled to a server 220 via a network 230, arranged in accordance with at least some embodiments described herein.

As depicted in FIG. 2, each of multiple surveillance apparatuses 210-1, 210-2, . . . , and 210-n may be configured to transmit a signal within a predetermined range. In some embodiments, the signal may be encoded with a camera ID of a corresponding surveillance apparatus, and the predetermined range may correspond to a FOV of the corresponding surveillance apparatus. Further, each of multiple surveillance apparatuses 210-1, 210-2, . . . , and 210-n may be communicatively coupled to server 220 via network 230. Network 230 may be of any type of network. In some embodiments, network 230 may be a wired network, such as, without limitation, local area network (LAN), wide area network (WAN), metropolitan area network (MAN), global area network such as the Internet, a Fibre Channel fabric, or any combination of such interconnects. The network 230 may also be a wireless network, such as, without limitation, mobile device network (GSM, CDMA, TDMA, and others), wireless local area network (WLAN) such as Wi-Fi, wireless Metropolitan area network (WMAN), infrared (IR), Bluetooth, Zigbee, or any other types of wireless communications.

Each of surveillance apparatuses 210-1, 210-2, . . . , and 210-n may be configured to transmit a corresponding camera ID to at least one mobile device located within each FOV, as described with reference to FIG. 1 above. Further, each of surveillance apparatuses 210-1, 210-2, . . . , and 210-n may be configured to record image data of an object (which may be a user of a mobile device that is configured to receive the camera ID) located within each FOV and store the recorded image data in each local memory. In some embodiments, each of surveillance apparatuses 210-1, 210-2, . . . , and 210-n may further be configured to store the recorded image data in a remote storage device such as, for example, a storage device associated with server 220. The storage device may be an internal device of server 220 or a separate device that is communicatively coupled to (and in some examples controlled by) server 220. By way of example, but not limitation, each of multiple surveillance apparatuses 210-1, 210-2, . . . , and 210-n may be configured to transmit the recorded image data to server 220 via network 230 for storing the image data in the storage device associated with server 220. In such cases, each of multiple surveillance apparatuses 210-1, 210-2, . . . , and 210-n may also transmit, to server 220, data including each camera ID and/or a timestamp relating to the recorded image data. Alternatively and/or additionally, instead of transmitting the recorded image data to server 220, each of multiple surveillance apparatuses 210-1, 210-2, . . . , and 210-n may be configured to transmit, to server 220, a link to the recorded image data. In this instance, server 220 may be configured to provide the link to the recorded image data upon receiving an access request from an authorized user. Then, the authorized user may retrieve and/or download the recorded image using the link and/or other index mechanism. Although examples relating to FIG. 2 are described as being server-based based on server 220, in some other embodiments, surveillance apparatuses 210-1, 210-2, . . . , and 210-n may be communicatively connected with each other (without a server, such as server 220) via, for example, a peer-to-peer network, an adhoc network, etc.

In some examples, each of surveillance apparatuses 210-1, 210-2, . . . , and 210-n may be configured to receive a mobile device ID (e.g., IMSI or some other identifier) from a mobile device (e.g., mobile device 120 from FIG. 1), such that the recorded image data may be stored in association with the mobile device ID. Then, mobile device 120 may access each of surveillance apparatuses 210-1, 210-2 and/or server 220 based on the mobile device ID to identify and download the recorded image data.

Server 220 may be communicatively coupled to multiple surveillance apparatuses 210-1, 210-2, . . . , and 210-n. In some embodiments, server 220 may be configured to receive image data recorded by and transmitted from each of multiple surveillance apparatuses 210-1, 210-2, . . . , and 210-n via network 230. Then, sever 220 may store the received image data with corresponding timestamp in the storage device associated with server 220. By way of example, but not limitation, the storage device may include multiple accounts, each of which may correspond to each of multiple surveillance apparatuses 210-1, 210-2, . . . , and 210-n and may be configured to store image data together with a timestamp, a camera ID and/or a mobile device ID of a mobile device that is captured in the image data, which are transmitted from corresponding one of multiple surveillance apparatuses 210-1, 210-2, . . . , and 210-n.

In some embodiments, server 220 may be configured to provide the image data stored in each local memory of multiple surveillance apparatuses 210-1, 210-2, . . . , and 210-n and/or in the storage device to an authorized user. By way of example, but not limitation, the authorized user may be a user of a mobile device (not shown in FIG. 2) which has received at least one camera ID from surveillance apparatuses 210-1, 210-2, . . . , and 210-n. The user of the mobile device may initiate access to server 220 using the mobile device or any other electronic devices and request server 220 to provide the stored image data corresponding to the at least one camera ID. The user may also specify a time, a time period or a range/span of times of the stored image data when he/she requests the stored image data. In response to the request, server 220 may provide the user with the stored image data corresponding to the at least one camera ID at the user specified time or the user specified time period. Alternatively and/or additionally, the user of the mobile device may request server 220 to provide a list of the stored image data (instead of the stored image data) corresponding to the at least one camera ID. The user may receive the list of the stored image data and submit the list to an authorized entity (such as, for example, police), or server 220 may directly provide the list of the stored image data to the authorized entity. In such cases, the stored image data may be provided only to the authorized entity, and thus privacy of other users in the stored image data can be ensured.

In some embodiments, server 220 may be configured to provide the user of the mobile device with the stored image data either in a high-resolution version or in a low-resolution version based on a request from the user. In such cases, the user may receive, from server 220, thumbnail images of the stored image data corresponding to the at least one camera ID, select one or more images to be downloaded in a high-resolution version and/or in a low-resolution version and transmit a request regarding the selection to server 220. Subsequently, server 220 may receive the request from the user and provide the stored image data in accordance with the request. Further, server 220 may charge the user for downloading the stored image data, and downloading fees may depend on the selected image resolution. By way of example, but not limitation, server 220 may charge more fees for a high-resolution version than for a low-resolution version.

In some embodiments, server 220 may provide a storage service. In such cases, server 220 may be configured to store image data transmitted from surveillance apparatuses 210-1, 210-2, . . . , and 210-n in the storage device for a certain period of time. For example, it may be assumed that a user and his/her mobile device were located within a FOV (FOV) of surveillance apparatus 210-1 at a specific time or during a specific time period. The mobile device may have received a camera ID of surveillance apparatus 210-1, and surveillance apparatus 210-1 may have recorded image data of at least the user and stored the recorded image data in the corresponding local memory. Further, surveillance apparatus 210-1 may have transmitted, to server 220, the recorded image data together with the camera ID and a timestamp corresponding to the image data recording time. Server 220 may have identified an account of surveillance apparatus 210-1 in the storage device based on the camera ID and stored the image data and the timestamp in the account of surveillance apparatus 210-1. In such cases, server 220 may be configured to delete the stored image data after a predetermined period due to, for example, lack of space on the storage device or a data storage policy that automatically expires data after a certain number of days, etc. However, the user may want to keep the image data in the storage device longer than the predetermined period and request a long-period storage of the image data by designating a storage period. Upon receiving the request, server 220 may set a storage time for the image data to the designated storage period. In some embodiments, server 220 may charge the user (or user account) for the long-period storage service depending on the designated storage period.

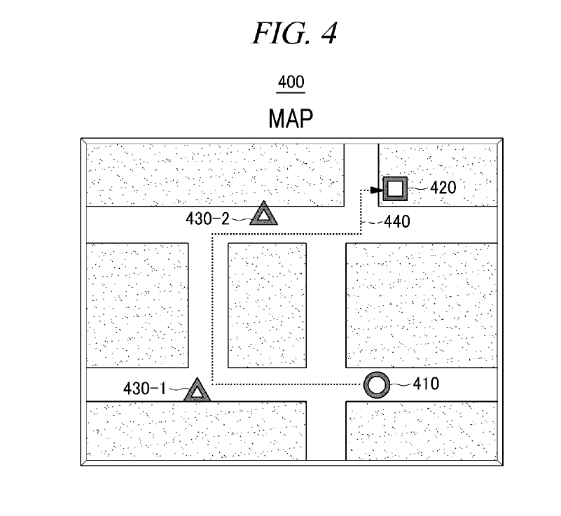

In some embodiments, server 220 may be configured to provide a map of at least one of multiple surveillance apparatuses 210-1, 210-2, . . . , and 210-n. In such cases, server 220 may receive, from a mobile device, a map request including a present location of the mobile device (or another location different from the present location). Then, server 220 may be configured to generate map data including a location of at least one of multiple surveillance apparatuses 210-1, 210-2, . . . , and 210-n around the present location of the mobile device (or another location different from the present location) and provide the map data to the mobile device. The map data may indicate the location of the at least one of multiple surveillance apparatuses 210-1, 210-2, . . . , and 210-n and may be displayed on a display unit of the mobile device. The user of the mobile device (who may want to be recorded by as many surveillance apparatuses as possible) may determine a route from the present location to a destination by referring to the location of the at least one of multiple surveillance apparatuses 210-1, 210-2, . . . , and 210-n. In some embodiments, server 220 may be further configured to provide a suggested route to the destination along which the user can pass by as many surveillance apparatuses as possible. In such cases, server 220 may further receive the selected destination from the mobile device, generate the suggested route with at least one of multiple surveillance apparatuses 210-1, 210-2, . . . , and 210-n, and provide the suggested route to the mobile device. Then, the mobile device may render the suggested routed being superimposed on the map, which may be displayed on the display unit of the mobile device. Various embodiments will be described more in detail with reference to FIG. 4 below.

In some embodiments, server 220 may be configured to provide a chronological history for a user of a mobile device. By way of example, but not limitation, the mobile device may send, to server 220, a request for a list of surveillance apparatuses around an approximate location for a specified period (e.g., a specified date or range of dates) when the user was located in the approximate location. In such cases, one or more of surveillance apparatuses 210-1, 210-2, . . . , and 210-n may have received a mobile device ID (e.g., IMSI or some other identifier) from the mobile device, such that recorded image data may be stored in association with the mobile device ID together with corresponding timestamps. Upon receiving the request, server 200 may identify recorded image data that substantially match the approximate location and the specified period based on the mobile camera ID, generate the list of surveillance apparatuses (which includes corresponding camera IDs and timestamps) and provide the list to the mobile device. In some non-limiting examples, server 220 may be configured to provide the mobile device with a map showing around the approximate location in which one or more surveillance apparatuses that may have captured image data of the mobile device are presented. In such a map, the corresponding timestamps, which indicate respective times when the mobile device was captured by corresponding surveillance apparatuses, may also be illustrated (e.g., by superimposition).

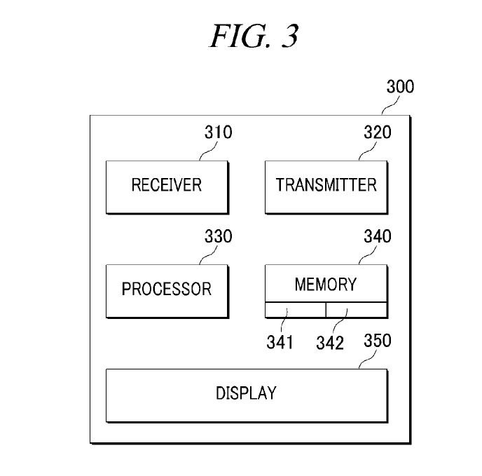

FIG. 3 schematically shows a block diagram of an example mobile device 300 configured to receive and store a camera ID 341 of a surveillance apparatus, arranged in accordance with at least some embodiments described herein.

As depicted, mobile device 300 may include one or more of a receiver 310, a transmitter 320, a processor 330, a memory 340, and/or a display 350. Although illustrated as discrete components, various components may be divided into additional components, combined into fewer components, or eliminated while being contemplated within the scope of the disclosed subject matter. It will be understood by those skilled in the art that each function and/or operation of the components may be implemented, individually and/or collectively, by a wide range of hardware, software, firmware, or virtually any combination thereof.

Receiver 310 may be configured to receive a transmission (e.g., a signal) from a surveillance apparatus located proximate to mobile device 300. The signal may include a camera ID associated with the surveillance apparatus. The camera ID of the surveillance apparatus may be any type of information (e.g., an analog identifier or a digital identifier) that can identify the surveillance apparatus. In some embodiments, the signal may further include a timestamp, which may include date information in addition to time information. By way of example, but not limitation, when the surveillance apparatus is capturing video images, the timestamp may include a start time and an end time for when mobile device 300 was located in a FOV of the surveillance apparatus or may include a start time and duration. Such timestamp may be encoded into the signal together with the camera ID of the surveillance apparatus. In such cases, the surveillance apparatus may be configured to generate the timestamp which corresponds to a time of recording for image data associated with the mobile device 300 (e.g., a time where the mobile device was located within the FOV).

In some embodiments, receiver 310 may be configured to receive the signal from the surveillance apparatus when mobile device 300 is located within the FOV of the surveillance apparatus. The FOV may correspond to a camera ID transmission range of the surveillance apparatus. In some examples, the camera ID transmission range of the surveillance apparatus may be determined based at least in part on a power level of transmitting the signal including the camera ID.

Transmitter 320 may be configured to transmit a user request to a server (such as, for example, server 220 of FIG. 2) via a network (such as, for example, network 230 of FIG. 2). Transmitter 320 may include an interface that is coupled to a user input unit that is configured to receive the user request. As described with reference FIG. 2 above, in some embodiments where the server can be configured to provide map data indicating at least one surveillance apparatus proximate to a location of the mobile device, the user may input a map request including a present location (or another location different from the present location) of the mobile device, and the transmitter 320 may transmit the map request to the server. Receiver 310 may be configured to receive the map data from the server, which may include a location of the at least one surveillance apparatus proximate to the present location (or another location different from the present location) of the mobile device.

By way of example, but not limitation, mobile device 300 may be configured to obtain a present location using, for example, a GPS receiver, a cellular location determination scheme, a triangulation determination scheme, etc. Further, when the server provides a route to a destination, the user may input (or otherwise select) the destination together with the map request, and transmitter 320 may also transmit the destination to the server. Receiver 310 may be configured to subsequently/responsively receive, from the server, the route from the present location (or selected location) of the mobile device to the destination. The route selected by the server may include an approximately maximum number of surveillance apparatuses present along the route to increase the likelihood of image data being captured along the selected route that include the user. The map data and the route may be displayed on display 350. In some examples, multiple possible routes may be presented to the user on display 350 so that the user may manually select a desired route.

Processor 330 may be configured to coordinate operation of one or more of receiver 310, transmitter 320, memory 340, and/or display 350. Memory 340 may be configured to store one or more of camera ID 341 of a surveillance apparatus, a corresponding timestamp 342, and/or image data received from the surveillance apparatus. Display 350 may be configured to display any response to a user request.

In some embodiments, the user of mobile device 300 may input, using the user input unit, a request to identify one or more camera IDs that captured images proximate to a specified time. Processor 330 may receive the request and search memory 340 to identify one or more camera IDs that are stored proximate to the specified time. When identifying the one or more camera IDs, processor 330 may refer to the timestamp stored in association with the corresponding camera ID in memory 340. Processor 330 may subsequently provide each identified camera ID to the user of mobile device 300. By way of example, but not limitation, processor 330 may be configured to generate a list of the identified at least one camera ID, and display 350 may display the list.

In some additional embodiments, the user of mobile device 300 may input, using the user input unit, a request to identify at least one camera ID stored in memory 340 proximate to a specified location. Processor 330 may receive the request and search memory 340 to identify one or more camera IDs that are proximate to the specified location (e.g., near a landmark, address, or GPS coordinate). When identifying the one or more camera IDs proximate to the specific location, processor 330 may refer to the timestamp stored in association with the corresponding camera ID in memory 340. Then, processor 330 may provide the identified at least one camera ID to the user of mobile device 300. By way of example, but not limitation, processor 330 may be configured to generate a list of the identified at least one camera ID, and display 350 may display the list.

In some examples, processor 330 may be configured to generate a set of graphical elements such as icons, symbols, text, or characters, where each of the graphical elements may correspond to a respective one of the identified camera IDs. The processor 330 may be further configured to communicatively cooperate with display 350 such that the generated graphical elements may be superimposed over a map of the region corresponding to the specified location.

In some additional examples, processor 330 may be configured to generate a set of representative images such as thumbnail images, where each of the set of representative images corresponds to an image captured by the corresponding one of the identified camera IDs. The display 350 may be utilized to display any variety of data associated with the identified camera IDs. Other combinations of displays that may include one or more of lists, graphical elements, representative images (e.g., thumbnail images), time/date stamps, and/or camera IDs can be arranged on display 350, and such combinations are contemplated in the present disclosure.

FIG. 4 schematically shows an example map 400 configured to indicate one or more surveillance apparatuses 430-1 and 430-2 that are configured to record image data and transmit a signal encoded with a camera ID, in accordance with at least some embodiments described herein. As depicted, map 400 may include a present location 410 of a mobile device, a user specified destination 420, locations of one or more surveillance apparatuses 430-1 and 430-2, and route 440. By way of example, but not limitation, map 400 may be generated by server 220 of FIG. 2 based on a request from mobile device 300 of FIG. 3. In such cases, mobile device 300 may transmit a map request including present location 410 and destination 420 to server 220, and in response to the request, server 220 may generate data for map 400, where the data may indicate one or more surveillance apparatuses 430-1 and 430-2 and a suggested route 440. In some examples, multiple possible routes may be presented to the user (e.g., on display 350) so that the user may manually select a desired route. In various examples the indicators may be represented as graphical elements such as icons, symbols, text, or characters, or any other variety of graphical element or graphical image that can be superimposed over map 400. As depicted in FIG. 4, present location 410 may be represented by a circular graphical icon, destination 420 may be represented by a rectangular graphical icon, and one or more surveillance apparatuses 430-1 and 430-2 may be represented by one or more triangular graphical icons. Further, each of the one or more triangular graphical icons may have a different color so that the user may distinguish each icon.

Route 440 may include an approximately maximum number of surveillance apparatuses present along the route, and thus may not be the shortest path to destination 420. As depicted in FIG. 4, route 440 directs the user of mobile device 300 to pass by one or more surveillance apparatuses 430-1 and 430-2, even though route 440 may be longer than the shortest path to destination 420. As such, since the user may be recorded by one or more surveillance apparatuses 430-1 and 430-2 as moving along route 440, the route 440 may be considered as a “safe path.” In other words, the proposed route 440 may be a “safe path” in that traversal of route 440 may increase the likelihood of image data being captured that includes the user in the image data.

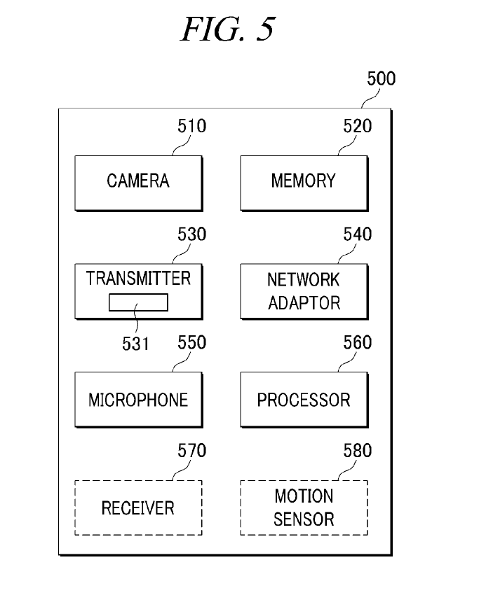

FIG. 5 schematically shows a block diagram of an example surveillance apparatus 500 configured to record image data and transmit a signal encoded with a camera ID, arranged in accordance with at least some embodiments described herein. As depicted, surveillance apparatus 500 may include one or more of a camera 510, a memory 520, a transmitter 530, a network adaptor 540, a microphone 550 and/or a processor 560. Further, surveillance apparatus 500 may optionally include a receiver 570 and/or a motion sensor 580. Although illustrated as discrete components, various components may be divided into additional components, combined into fewer components, or eliminated while being contemplated within the scope of the disclosed subject matter. It will be understood by those skilled in the art that each function and/or operation of the components may be implemented, individually and/or collectively, by a wide range of hardware, software, firmware, or virtually any combination thereof.

Camera 510 may be configured to record image data within a corresponding FOV. This FOV may be an area that camera 520 can distinguish and/or identify an object located within the area.

Memory 520 may be configured to store the recorded image data by camera 510. In some embodiments, memory 520 may store the recorded image data together in association with a timestamp. The timestamp may correspond to a time when camera 510 records the image data.

Transmitter 530 may be configured to transmit a signal including a camera ID of surveillance apparatus 500 to a mobile device located within a predetermined range. Transmitter 530 may include an encoder 531 configured to encode the signal with the camera ID and/or the timestamp corresponding to the recorded image data. The encoder 531 may be configured to encode using any variety of analog or digital encoding methods. Example analog encoding methods may include one or more of amplitude modulation, double-sideband modulation, single-sideband modulation, vestigial sideband modulation, quadrature amplitude modulation, frequency modulation, phase modulation, pulse code modulation or other analog encoding methods. Example digital encoding methods may include one or more of digital modulation methods based on phase-shift keying, frequency-shift keying, amplitude-shift keying, quadrature amplitude modulation or other digital encoding methods. In some embodiments, the predetermined range may correspond to the FOV of surveillance apparatus 500 so that the mobile device located within FOV may receive the signal. By way of example, but not limitation, the signal may have high directionality such that the predetermined range corresponds to the FOV of surveillance apparatus 500.

In some embodiments, transmitter 530 may be configured to transmit the signal at a predetermined transmission power level. The predetermined transmission power level may be determined based on a FOV of surveillance apparatus 500. For example, the predetermined transmission power level may be calculated based on at least one of a transmission gain of transmitter 530, an extension of radiation of the signal, a free-space decrement coefficient, a reflection coefficient of surroundings, etc.

Network adaptor 540 may be configured to communicatively couple the surveillance apparatus 500 to a server (e.g., such as server 220 in FIG. 2). In some embodiments, surveillance apparatus 500 may be configured to transmit the recorded image data to the server via network adaptor 540.

Microphone 550 may be configured to capture an ambient sound when camera 510 records the image data of the mobile device (and consequently a user of the mobile device). The captured sound may include a voice of the user of the mobile device and/or an ambient sound around the mobile device located within the FOV of surveillance apparatus 500. In some embodiments, the captured sound may be encoded with the recorded image data to generate audio-video image data, which may be stored in memory 520.

Processor 560 may be configured to coordinate operation of one or more of camera 510, memory 520, transmitter 530, network adaptor 540 and/or microphone 550. In cases where surveillance apparatus 500 further optionally includes receiver 570 and/or motion sensor 580, processor 560 may be configured to further coordinate operation of receiver 570 and/or motion sensor 580, which will be described below.

In some embodiments, surveillance apparatus 500 may optionally further include receiver 570 configured to receive a mobile device ID that may be received from the mobile device, such that the recorded image data may be stored in association with the mobile device ID in memory 520. In some other embodiments, surveillance apparatus 500 may optionally further include motion sensor 580 configured to detect an object within the FOV and then to trigger image data recording by surveillance apparatus 500. In such cases, transmitter 530 may be operated with little or no power consumption (e.g., the transmitter may be turned off or operated in a low power or standby mode) until motion sensor 580 triggers the image data recording.

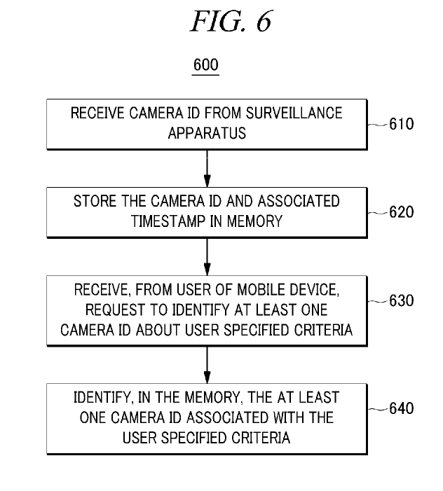

FIG. 6 schematically shows an example flow diagram of a method for handling a camera ID transmitted from a surveillance apparatus arranged in accordance with at least some embodiments described herein.

Method 600 may be implemented in a mobile device such as mobile device 300 including one or more of receiver 310, transmitter 320, processor 330, memory 340 and/or display 350. Method 600 may include one or more operations, actions, or functions as illustrated by one or more of blocks 610, 620, 630 and/or 640. Although illustrated as discrete blocks, various blocks may be divided into additional blocks, combined into fewer blocks, or eliminated, depending on the desired implementation. In some further examples, the various described blocks may be implemented as a parallel process instead of a sequential process, or as a combination thereof.

Method 600 may begin at block 610, “RECEIVE CAMERA ID FROM SURVEILLANCE APPARATUS.” At block 610, the mobile device (e.g., receiver 310 in FIG. 3) may be adapted to receive a signal including a camera ID from a surveillance apparatus (such as, for example, surveillance apparatus 500 of FIG. 5). The camera ID may be encoded with the signal by any variety analog or digital encoding methods described previously. The camera ID may be recovered or extracted from the received signal via any variety of decoding methods that are mated to the encoding methods.

Block 610 may be followed by block 620, “STORE THE CAMERA ID AND ASSOCIATED TIMESTAMP IN MEMORY.” At block 620, the mobile device (e.g., memory 340 in FIG. 3) may be adapted to store the camera ID with a timestamp corresponding to a time when the mobile device (and consequently a user of the mobile device) is located within a FOV of the surveillance apparatus. In some embodiments, the timestamp may be generated by the surveillance apparatus, where such timestamp may be encoded in a signal transmitted from the surveillance apparatus to each mobile device located within the FOV. In some other embodiments, the mobile device may be configured to generate the timestamp. In such cases, the mobile device may include an internal watch, or the mobile device may receive current time information through a network watch or a GPS receiver. Block 620 may be followed by block 630, “RECEIVE, FROM USER OF MOBILE DEVICE, REQUEST TO IDENTIFY AT LEAST ONE CAMERA ID ABOUT USER SPECIFIED CRITERIA.” At block 630, the mobile device (e.g., receiver 310 in FIG. 3) may receive a request from the user of the mobile device to identify at least one camera ID about a user specified criteria, where the criteria may be associated with a user specified time and/or a user specified location. In some embodiments, the user may input the request with the user specified criteria using an input device that is either part of the mobile device or operatively coupled to the mobile device.

Block 630 may be followed by block 640, “IDENTIFY, IN THE MEMORY, THE AT LEAST ONE CAMERA ID ASSOCIATED WITH THE USER SPECIFIED CRITERIA.” At block 640, the mobile device (e.g., processor 330 in FIG. 3) may search a local memory (e.g., memory 340 in FIG. 3) to identify the at least one camera ID associated with the user specified criteria based, at least in part, on at least one timestamp stored together with the at least one camera ID in the local memory. When the mobile device identifies the at least one camera ID associated with the user specified criteria, the mobile device (e.g., display 350 in FIG. 3) may provide the user with the identified at least one camera ID (e.g., by displaying a list, or graphical elements, or graphical images of the identified at least one camera ID).

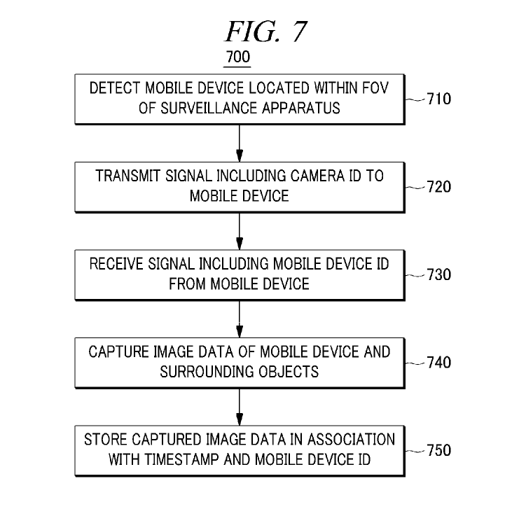

FIG. 7 schematically shows a flow diagram of an example method performed by a surveillance apparatus, arranged in accordance with at least some embodiments described herein.

Method 700 may be implemented in a such as surveillance apparatus 500 including one or more of camera 510, memory 520, transmitter 530, network adaptor 540, microphone 550, processor 560, receiver 570 and/or motion sensor 580. Although illustrated as discrete blocks, various blocks may be divided into additional blocks, combined into fewer blocks, or eliminated, depending on the desired implementation. In some further examples, the various described blocks may be implemented as a parallel process instead of a sequential process, or as a combination thereof.

Method 700 shown in FIG. 7 may begin at block 710, “DETECT MOBILE DEVICE LOCATED WITHIN FOV OF SURVEILLANCE APPARATUS.” At block 710, the surveillance apparatus (e.g., motion sensor 580 in FIG. 5) may be adapted to detect a mobile device (such as, for example, mobile device 300 of FIG. 3) located within the FOV of the surveillance apparatus. Then, the surveillance apparatus is activated to perform one or more of the below-described operations.

Block 710 may be followed by block 720, “TRANSMIT SIGNAL INCLUDING CAMERA ID TO MOBILE DEVICE.” At block 710, the surveillance apparatus (e.g., transmitter 530 in FIG. 5) may transmit a signal including a camera ID of the surveillance apparatus to the mobile device located within the FOV. The signal may be encoded with the camera ID and/or a timestamp. The surveillance apparatus (e.g., encoder 531) may be configured to encode using any variety of analog or digital encoding methods. Example analog encoding methods may include one or more of amplitude modulation, double-sideband modulation, single-sideband modulation, vestigial sideband modulation, quadrature amplitude modulation, frequency modulation, phase modulation, pulse code modulation or other analog encoding methods. Example digital encoding methods may include one or more of digital modulation methods based on phase-shift keying, frequency-shift keying, amplitude-shift keying, quadrature amplitude modulation or other digital encoding methods.

Block 720 may be followed by block 730, “RECEIVE SIGNAL INCLUDING MOBILE DEVICE ID FROM MOBILE DEVICE.” At block 720, the surveillance apparatus (e.g., receiver 570 in FIG. 5) may receive a signal including a mobile device ID (e.g., IMSI or some other identifiers) from the mobile device. The mobile device ID may be encoded with the signal by any variety analog or digital encoding methods described previously. The mobile device ID may be recovered or extracted from the received signal via any variety of decoding methods that are mated to the encoding methods.

In some embodiments, the signal from the mobile device may be a response to the signal transmitted from the surveillance apparatus. By way of example, but not limitation, the signal transmitted from the surveillance apparatus may be notified to a user of the mobile device such as, for example, by displaying the camera ID and/or the location of the surveillance apparatus on a display (e.g., display 350 of FIG. 5). Then, the user of the mobile device may input, using a user input unit associated with the mobile device, a request to send the mobile device ID to the surveillance apparatus. Further, the user of the mobile device may further input, using the user input unit associated with the mobile device, a request to capture image data to the surveillance apparatus. Such requests (including the mobile device ID) may be encoded to the signal that is received by the surveillance apparatus.

Block 730 may be followed by block 740, “CAPTURE IMAGE DATA OF MOBILE DEVICE AND SURROUNDING OBJECTS.” At block 730, the surveillance apparatus (e.g., camera 510 of FIG. 5) may capture image data of the mobile device and its surrounding objects including the user of the mobile device. The image data may correspond to one or more of video images, still images, or audio-video images.

Block 740 may be followed by block 750, “STORE CAPTURED IMAGE DATA IN ASSOCIATION WITH TIMESTAMP AND MOBILE DEVICE ID.” At block 740, the surveillance apparatus may store the image data in association with the corresponding timestamp (which may be generated by using an internal clock of the surveillance apparatus, by receiving time information through a network watch or a GPS receiver, or by any appropriate time clock means such as an atomic clock, radio signal based clock, etc.) and the received mobile device ID in a local memory and/or a remote storage device. Then, the stored image data may be provided to the user of the mobile device or an authorized user upon his/her request. In some examples, the mobile device may access the surveillance apparatus or the remote storage device to download the recorded image data.

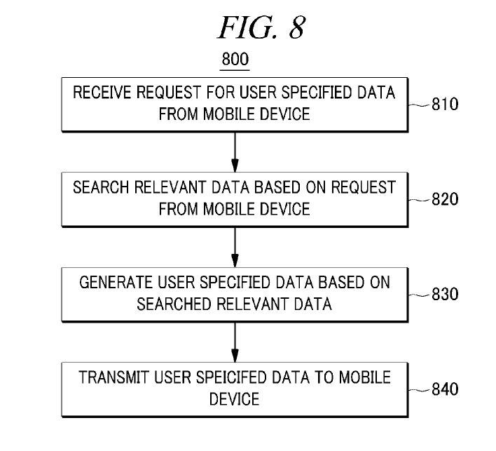

FIG. 8 schematically shows a flow diagram of an example method performed by a server to which one or more surveillance apparatuses are coupled, arranged in accordance with at least some embodiments described herein.

Method 800 may be implemented in a server such as server 220, to which one or more surveillance apparatuses are coupled via a network. Method 800 may include one or more operations, actions, or functions as illustrated by one or more of blocks 810, 820, 830 and/or 840. Although illustrated as discrete blocks, various blocks may be divided into additional blocks, combined into fewer blocks, or eliminated, depending on the desired implementation. In some further examples, the various described blocks may be implemented as a parallel process instead of a sequential process, or as a combination thereof.

Method 800 shown in FIG. 8 may begin at block 810, “RECEIVE REQUEST FOR USER SPECIFIED DATA FROM MOBILE DEVICE.” At block 810, the server may be adapted to receive a request for user specified data from a mobile device (such as, for example, mobile device 300 of FIG. 3). By way of example, but not limitation, the server may include a signal receiver that is configured to receive a signal encoded with the request for user specified data using any variety of analog or digital encoding methods. Example analog encoding methods may include one or more of amplitude modulation, double-sideband modulation, single-sideband modulation, vestigial sideband modulation, quadrature amplitude modulation, frequency modulation, phase modulation, pulse code modulation or other analog encoding methods. Example digital encoding methods may include one or more of digital modulation methods based on phase-shift keying, frequency-shift keying, amplitude-shift keying, quadrature amplitude modulation or other digital encoding methods. Further, the server may include a decoder that is configured to decode the received signal to recover or extract the request for user specified data from the received signal via any variety of decoding methods that are mated to the above encoding methods.

In some embodiments, the user specified data can be any types of data specified by a user of the mobile device and may be associated with the one or more surveillance apparatuses and/or image data captured by the one or more surveillance apparatuses. In one non-limiting example, the requested user specified data may include data associated with a map of at least one of the one or more surveillance apparatuses located around a present location of the mobile device (or another location different from the present location of the mobile device). In another non-limiting example, the requested user specified data may include image data associated with user specified criteria, which may include time information and/or location information. In yet another non-limiting example, the requested user specified data may include image data associated with a mobile device ID of the mobile device. Various other examples are also available within the scope of the present disclosure.

Block 810 may be followed by block 820, “SEARCH RELEVANT DATA BASED ON REQUEST FROM MOBILE DEVICE.” At block 820, the server may search for data relevant to the received request for user specified data. By way of example, but not limitation, the relevant data may be stored in a local storage of the server or a remote storage such as, for example, a cloud datacenter. One or more processors included in the server may search the local storage or the remote storage and retrieve the relevant data from the local storage or the remote storage.

In cases where the requested user specified data include data associated with the map, the retrieved data may include information about at least one surveillance apparatus located around the present location of the mobile device (or the other location different from the present location of the mobile device). In cases where the requested user specified data include image data associated with the user specified criteria, the retrieved data may include one or more image data that substantially match the user specified criteria. In cases where the requested user specified data include image data associated with the mobile device ID of the mobile device, the retrieved data may include one or more image data that have been stored in association with the mobile device ID of the mobile device.

Block 820 may be followed by block 830, “GENERATE USER SPECIFIED DATA BASED ON SEARCHED RELEVANT DATA.” At block 830, the server (e.g., the one or more processors, as described above) may generate the user specified data based on the retrieved data and the request from the mobile device. In cases where the requested user specified data include data associated with the map, the server may generate a map showing the present location of the mobile device (or the other location different from the present location of the mobile device) and at least one surveillance apparatus located around the present location of the mobile device (or the other location different from the present location of the mobile device). Alternatively, the server may generate image data relating to the map, and the mobile device may receive the image data and reconstruct the map. In some embodiments, the user of the mobile device may further request a route to a destination, and the server may generate one or more routes from the present location (or the selected location) of the mobile device to the destination. The route selected by the server may include an approximately maximum number of surveillance apparatuses present along the route to increase the likelihood of image data being captured along the selected route that include the user.

Block 830 may be followed by block 840, “TRANSMIT USER SPECIFIED DATA TO MOBILE DEVICE.” At block 840, the server may transmit the generated user specified data to the mobile device. By way of example, but not limitation, the server may include a signal transmitter that is configured to transmit the generated user specified data to the mobile device through wireless data communication. The wireless data communication may be based on any variety of networks such as, for example, a cellular network, a Wi-Fi network, etc. The mobile device may then receive and display the user specified data on a display unit.

One skilled in the art will appreciate that, for this and other methods disclosed herein, the functions performed in the methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

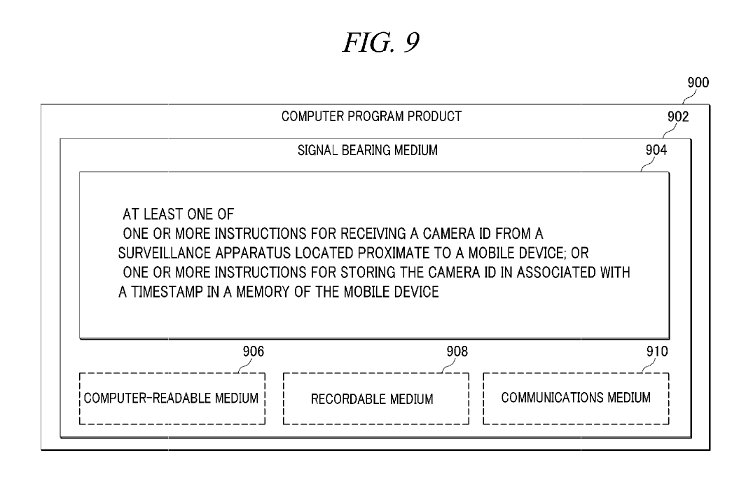

FIG. 9 illustrates computer program products 900 that may be utilized to handle camera IDs of surveillance apparatuses, in accordance with at least some embodiments described herein. Program product 900 may include a signal bearing medium 902. Signal bearing medium 902 may include one or more instructions 904 that, when executed by, for example, a processor, may provide the functionality described above with respect to FIGS. 1 to 8. By way of example, instructions 904 may include: one or more instructions for receiving a camera ID from a surveillance apparatus located proximate to a mobile device; or one or more instructions for storing the camera ID and a timestamp in a memory of the mobile device. Thus, for example, referring to FIG. 3, processor 330 of mobile device 300 may undertake one or more of the blocks shown in FIG. 6 in response to instructions 904.

In some implementations, signal bearing medium 902 may encompass a computer-readable medium 906, such as, but not limited to, a hard disk drive, a Compact Disc (CD), a Digital Video Disk (DVD), a digital tape, memory, etc. In some implementations, signal bearing medium 902 may encompass a recordable medium 808, such as, but not limited to, memory, read/write (R/W) CDs, R/W DVDs, etc. In some implementations, signal bearing medium 902 may encompass a communications medium 910, such as, but not limited to, a digital and/or an analog communication medium (e.g., a fiber optic cable, a waveguide, a wired communications link, a wireless communication link, etc.). Thus, for example, program product 900 may be conveyed to mobile device 300 by an RF signal bearing medium 902, where the signal bearing medium 902 is conveyed by a wireless communications medium 910 (e.g., a wireless communications medium conforming with the IEEE 802.11 standard).

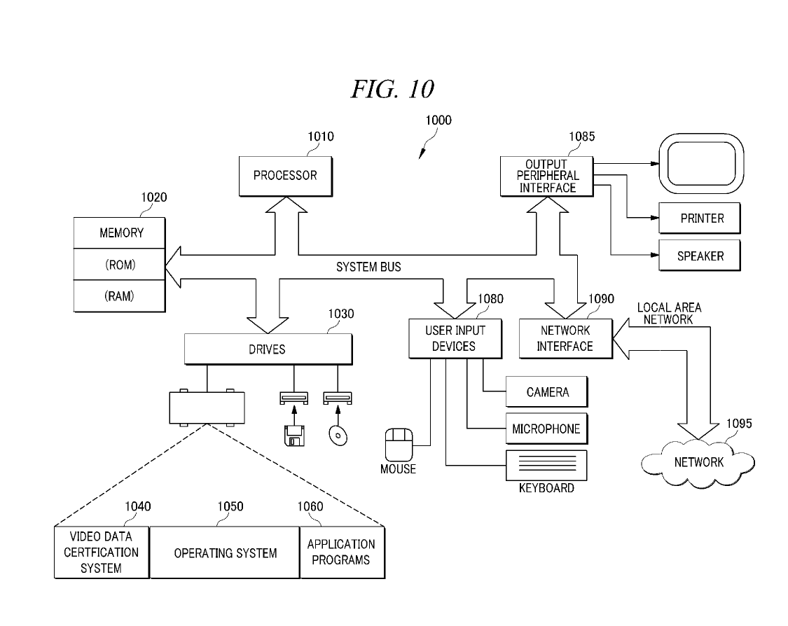

FIG. 10 shows a schematic block diagram illustrating an example computing system that can be configured to implement methods for handling camera IDs, arranged in accordance with at least some embodiments described herein. As depicted in FIG. 10, a computer 1000 may include a processor 1010, a memory 1020 and one or more drives 1030. Computer 1000 may be implemented as a conventional computer system, an embedded control computer, a laptop, or a server computer, a mobile device, a set-top box, a kiosk, a vehicular information system, a mobile telephone, a customized machine, or other hardware platform.

Drives 1030 and their associated computer storage media may provide storage of computer readable instructions, data structures, program modules and other data for computer 1000. Drives 1030 may include a image data certification system 1040, an operating system (OS) 1050, and application programs 1060. Video data certification system 1040 may be adapted to handle camera IDs of surveillance apparatuses in such a manner as described above with respect to FIGS. 1 to 9.

Computer 1000 may further include user input devices 1080 through which a user may enter commands and data. Input devices may include an electronic digitizer, a camera, a microphone, a keyboard and pointing device, commonly referred to as a mouse, trackball or touch pad. Other input devices may include a joystick, game pad, satellite dish, scanner, or the like.

These and other input devices may be coupled to processor 1010 through a user input interface that is coupled to a system bus, but may be coupled by other interface and bus structures, such as a parallel port, game port or a universal serial bus (USB). Computers such as computer 1000 may also include other peripheral output devices such as display devices, which may be coupled through an output peripheral interface 1085 or the like.

Computer 1000 may operate in a networked environment using logical connections to one or more computers, such as a remote computer coupled to a network interface 1090. The remote computer may be a personal computer, a server, a router, a network PC, a peer device or other common network node, and may include many or all of the elements described above relative to computer 1000.

Networking environments are commonplace in offices, enterprise-wide area networks (WAN), local area networks (LAN), intranets, and the Internet. When used in a LAN or WLAN networking environment, computer 1000 may be coupled to the LAN through network interface 1090 or an adapter. When used in a WAN networking environment, computer 1000 typically includes a modem or other means for establishing communications over the WAN, such as the Internet or a network 1095. The WAN may include the Internet, the illustrated network 1095, various other networks, or any combination thereof. It will be appreciated that other mechanisms of establishing a communications link, ring, mesh, bus, cloud, or network between the computers may be used.

In some embodiments, computer 1000 may be coupled to a networking environment. Computer 1000 may include one or more instances of a physical computer-readable storage medium or media associated with drives 1030 or other storage devices. The system bus may enable processor 1010 to read code and/or data to/from the computer-readable storage media. The media may represent an apparatus in the form of storage elements that are implemented using any suitable technology, including but not limited to semiconductors, magnetic materials, optical media, electrical storage, electrochemical storage, or any other such storage technology. The media may represent components associated with memory 1020, whether characterized as RAM, ROM, flash, or other types of volatile or nonvolatile memory technology. The media may also represent secondary storage, whether implemented as storage drives 1030 or otherwise. Hard drive implementations may be characterized as solid state, or may include rotating media storing magnetically encoded information.

Processor 1010 may be constructed from any number of transistors or other circuit elements, which may individually or collectively assume any number of states. More specifically, processor 1010 may operate as a state machine or finite-state machine. Such a machine may be transformed to a second machine, or specific machine by loading executable instructions. These computer-executable instructions may transform processor 1010 by specifying how processor 1010 transitions between states, thereby transforming the transistors or other circuit elements constituting processor 1010 from a first machine to a second machine. The states of either machine may also be transformed by receiving input from user input devices 1080, network interface 1090, other peripherals, other interfaces, or one or more users or other actors. Either machine may also transform states, or various physical characteristics of various output devices such as printers, speakers, video displays, or otherwise.

The present disclosure is not to be limited in terms of the particular embodiments described in this application, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

The herein described subject matter sometimes illustrates different components contained within, or coupled with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected,” or “operably coupled,” to each other to achieve the desired functionality, and any two components capable of being so associated may also be viewed as being “operably couplable,” to each other to achieve the desired functionality Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” and the like include the number recited and refer to ranges which may be subsequently broken down into subranges as discussed above. Finally, as will be understood by one skilled in the art, a range includes each individual member.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method performed under control of a mobile device, the method comprising:
receiving a camera ID from a surveillance apparatus located proximate to the mobile device; and
storing the camera ID in association with a timestamp in a memory of the mobile device.

2. The method of claim 1, wherein the receiving the camera ID comprises receiving the camera ID from the surveillance apparatus when the mobile device is located within a field of view of the surveillance apparatus.

3. The method of claim 1, wherein the receiving the camera ID comprises receiving the camera ID from the surveillance apparatus when the mobile device is located within a camera ID transmission range of the surveillance apparatus, wherein the camera ID transmission range is determined based, at least in part, on a transmission power level of the surveillance apparatus.

4. The method of claim 1, further comprising:
receiving a request to identify at least one camera ID based on a user specified criteria; and
identifying, in the memory of the mobile device, at least one camera ID that substantially matches the user specified criteria.

5. The method of claim 4, further comprising:
providing the identified at least one camera ID to the user of the mobile device.

6. The method of claim 5, wherein the providing the identified at least one camera ID comprises displaying, on a display of the mobile device, at least one of the identified at least one camera ID or image data associated with the identified at least one camera ID.

7. The method of claim 1, further comprising:
receiving a request to identify at least one camera ID based on a user specified time; and
identifying, in the memory of the mobile device, at least one camera ID that is associated with a timestamp that is substantially proximate to the user specified time.

8. The method of claim 1, further comprising:
receiving a request to identify at least one camera ID based on a user specified location; and
identifying, in the memory of the mobile device, at least one camera ID that is associated with the user specified location.

9. The method of claim 1, further comprising:
sending, to a server device, a request to identify one or more camera IDs associated with a user specified criteria; and
receiving, from the server device, data that identifies at least one camera ID that substantially matches the user specified criteria.

10. The method of claim 9, further comprising:
providing the data that identifies the at least one camera ID to the user of the mobile device.

11. The method of claim 10, wherein the providing the data comprises displaying, on a display of the mobile device, the data that identifies the at least one camera ID.

12. The method of claim 1, further comprising:
receiving a request to identify at least one camera ID based on a user specified location;
sending, to a server device, a request to identify one or more camera IDs associated with the user specified location; and
receiving, from the server device, data that identifies at least one camera ID that substantially matches the user specified location.

13. The method of claim 1, further comprising:
receiving a request to identify at least one camera ID based on a user specified time;
sending, to a server device, a request to identify one or more camera IDs associated with the user specified time; and
receiving, from the server device, data that identifies at least one camera ID that substantially matches the user specified time.

14. The method of claim 1, further comprising:
transmitting, to a server device, a data request that includes a user specified location; and
receiving, from the server, one or more data that correspond to the user specified location.

15. The method of claim 1, further comprising:
transmitting, to a server device, a route request that includes a user specified location and a user specified destination; and
receiving, from the server device, route data that corresponds to one or more routes from the user specified location to the user specified destination, wherein the one or more routes are associated with routes with an increased likelihood of exposure to surveillance apparatuses.

16. The method of claim 15, further comprising:
displaying the route data corresponding to the one or more routes on a display of the mobile device.

17. The method of claim 1, further comprising:
receiving the timestamp from the surveillance apparatus.

18. The method of claim 1, further comprising:
generating the timestamp.

19. A mobile device comprising:
a receiver configured to receive a signal transmission from a surveillance apparatus located proximate to the mobile device, wherein the signal transmission from the surveillance apparatus includes a camera ID;
a memory; and
a processor configured to coordinate operation of the receiver and the memory to store the camera ID received from the receiver in association with a timestamp in the memory.

20. The mobile device of claim 19, wherein the processor is further configured to:
receive a request to identify at least one camera ID associated with a user specified criteria; and
identify one or more camera IDs that substantially match the user specified criteria.

21. The mobile device of claim 20, wherein the user specified criteria includes at least one of a user specified time or a user specified location.

22. The mobile device of claim 19, wherein the receiver is further configured to receive the signal transmission from the surveillance apparatus when the mobile device is located within a field of view of the surveillance apparatus.

23. The mobile device of claim 19, wherein the receiver is further configured to receive the signal transmission from the surveillance apparatus when the mobile device is located within a camera ID transmission range of the surveillance apparatus, wherein the camera ID transmission range is determined based, at least in part, on a transmission power level of the surveillance apparatus.

24. The mobile device of claim 19, further comprising:
a transmitter configured to transmit, to a server device, a request to identify one or more camera IDs associated with a user specified criteria;
wherein the user specified criteria includes at least one of a user specified time or a user specified location, and
wherein the receiver is further configured to receive, from the server device, data that identifies at least one camera ID that substantially matches the user specified criteria.

25. The mobile device of claim 24, further comprising:
a display configured to display the data that identifies the at least one camera ID.

26. The mobile device of claim 19, further comprising:
a transmitter configured to transmit, to a server device, a route request that includes a user specified location and a user specified destination,
wherein the receiver is further configured to receive, from the server device, route data that corresponds to one or more routes from the user specified location to the user specified destination, and
wherein the one or more routes are associated with routes with an increased likelihood of exposure to surveillance apparatuses.

27. The mobile device of claim 26, further comprising:
a display configured to display the route data.

28. A surveillance apparatus comprising:
a camera configured to record image data;
a memory configured to store the recorded image data; and
a signal transmitter configured to transmit a signal to a mobile device located proximate to the surveillance apparatus, wherein the signal is encoded with a camera ID of the surveillance apparatus.

29. The surveillance apparatus of claim 28, wherein the memory is further configured to store a timestamp associated with the recorded image data, and
wherein the signal is further encoded with the timestamp associated with the recorded image data.

30. The surveillance apparatus of claim 28, wherein the signal transmitter is further configured to transmit the signal as a directional signal.

31. The surveillance apparatus of claim 28, wherein the signal transmitter is further configured to transmit the signal at a predetermined transmission power level that is determined based, at least in part, on a field of view of the surveillance apparatus.

32. The surveillance apparatus of claim 28, further comprising:
a network adaptor configured to transmit the recorded image data to a server.

33. The surveillance apparatus of claim 28, further comprising:
a receiver configured to receive a mobile device ID from the mobile device,
wherein the memory is further configured to store the recorded image data in association with the mobile device ID.

34. A system comprising:
one or more surveillance apparatuses, each configured to include:
a camera configured to record image data; and
a signal transmitter configured to transmit a signal to a mobile device located proximate to the surveillance apparatus, wherein the signal is encoded with a camera ID of the surveillance apparatus; and
a server configured to:
receive the recorded image data from the one or more surveillance apparatuses; and
store the received image data in a memory of the server.

35. The system of claim 34, wherein the signal transmitter is further configured to transmit the signal as a directional signal.

36. The system of claim 34, wherein each of the one or more surveillance apparatuses is further configured to transmit the signal at a predetermined transmission power level that is determined based at least in part on a field of view of each of the one or more surveillance apparatuses.

37. The system of claim 34, wherein the server is further configured to:
receive, from the mobile device, a request to identify one or more camera IDs associated with a user specified criteria; and
provide the mobile device data that identifies at least one camera ID that substantially matches the user specified criteria.

38. The system of claim 37, wherein the user specified criteria includes at least one of a user specified time or a user specified location.

39. The system of claim 34, wherein the server is further configured to:
receive, from the mobile device, a route request that includes a user specified location and a user specified destination; and
provide the mobile device with route data that corresponds to one or more routes from the user specified location to the user specified destination,
wherein the one or more routes are associated with routes with an increased likelihood of exposure to surveillance apparatuses.
